(19) United States
(12) Patent Application Publication
(10) Pub. No.: US 2010/0011919 A1
(43) Pub. Date: Jan. 21, 2010

(54) DEVICE AND METHOD FOR LEVELLING OFF THE SURFACE OF A BRAKE DISC

(75) Inventors: Frank Creemers, GL Leusden (NL); Willem Adriaan Nell, AM Overberg (NL); Rene Johannes Adriana Maria Jurriens, ET Oosterbeek (NL)

Correspondence Address: OBLON, SPIVAK, MCCLELLAND MAIER & NEUSTADT, L.L.P., 1940 DUKE STREET, ALEXANDRIA, VA, 22314, US

(73) Assignee: M.A.D. HOLDING B.V., KW Veenendaal (NL)

(21) Appl. No.: 12/375,537

(22) PCT Filed: Jul. 27, 2007
(86) PCT No.: PCT/NL2007/050377

§ 371 Date: Jul. 2, 2009

(30) Foreign Application Priority Data
Jul. 31, 2006 (NL) NL1032256

(51) Int. Cl. B23B 5/04

(52) U.S. Cl. 82/1.11; 82/112

(57) ABSTRACT

There is disclosed a device (1) for resurfacing an axle-mounted brake disc (2), comprising means (7) for mounting the device (1) to the vehicle, means (9) for moving a part of the device with respect to an auxiliary shaft (8) extending substantially parallel to the axle, means (12) for rotating the axle, and drivable brake disc machining means (11) mounted on the movable part of the device. Advantageously, the resurfacing of a brake disc in mounted condition on the vehicle takes place by driving the machining means (11), and any movement of the brake disc (2) itself may take place slowly, so that every part thereof can be worked.

The present invention relates to a device and a method for resurfacing brake discs mounted on the axle of a vehicle, in particular a car or a truck, but usually not a train.

Such a device and method are known, for example from U.S. Pat. No. 5,381,630, where a brake disc is removed from a vehicle and set up in a device, after which the brake disc is resurfaced by grinding.

This manner of operation is time-consuming and leads to inaccuracies, inter alia because of the mounting and is demounting operations that are required before resurfacing of the brake disc can take place.

From US 2005/0016338 and US 2005/0022639 on-car lathes are known for resurfacing the brake disc mounted on the vehicle axle. Said vehicle axle is driven, possibly at a variable speed, and the brake disc thus being rotationally driven is worked by machining means in the form of a cutting tool. The cutting tool is mounted on an auxiliary shaft that extends parallel to the vehicle axle, which auxiliary shaft can be moved as a whole in a direction transversely to the direction of the vehicle axle for working the entire brake disc.

From WO 98/09754 it is known to mount the device to the end of an axle and rotate the brake disc, which is still mounted on the axle, by means of a drive motor at a speed which imparts a required cutting speed to tools for machining the brake disc surface.

A drawback of all the techniques known from the aforesaid publications is that a relatively great deal of energy is required for imparting the speed required for the resurfacing operation to the brake disc and the axle and all the components mounted thereto and maintain said speed during the resurfacing operating. Apart from the vibrations that occur during said operation, which lead to inaccuracies in the end result, and the accompanying high noise level, it is difficult in the case of a large number of vehicles, or additional time-consuming operations must be carried out, to disable or disconnect a controlled slip differential or traction control system temporarily, for example, because otherwise it is not possible to realise the rotational speed that is needed for the resurfacing of the brake disc.

The object of the present invention is to provide a device and method which can be used with all kinds of vehicle types, in particular cars, and which require less energy, by means of which an accuracy level within close tolerances of the main quality-determining parameters of brake discs can be achieved by comparatively low-skilled workers in a short period of time.

In order to accomplish that object, the device according to the invention for resurfacing an axle-mounted brake disc comprises means for mounting the device to the vehicle, means for moving a part of the device with respect to an auxiliary shaft extending substantially parallel to the axle, means for rotating the axle, and drivable brake disc machining means mounted on the movable part of the device.

In the corresponding method a rotating axle-mounted brake disc is resurfaced by driven brake disc machining means that describe a movement over the brake disc surface.

The advantage of the device and method according to the invention is that the device itself provides the required machining movement of the machining means for working the brake disc surface, whilst the brake disc need not be removed from the vehicle. The brake disc, the axle etc need not be driven for this purpose. In practice, however, it will be necessary to impart a slow rotational speed to the brake disc, because the brake disc cannot be stationary if machining takes place circumferentially and the presence of obstacles renders such a circumferential operation impossible, which rotational speed is not required for the cutting operation, however, but which only needs to be sufficient to enable the driven machining means to work all the parts of the brake disc surface. Such a slow rotational speed requires less energy, is safer and produces less vibration and, in addition, does not lead to the above problems if the vehicle is fitted with one or more of the aforesaid systems, because said systems by nature do not block a slow rotational speed of the axle.

One embodiment of the device according to the invention is characterised in that the means for moving said part of the device comprise means which are capable of tilting movement about the auxiliary shaft or means which are capable of translating movement with respect to the auxiliary shaft.

Advantageously, the carrying out of a simple translating, usually linear, movement or a tilting movement about the auxiliary shaft so as to move the machining means over the brake disc surface after the device has been correctly mounted and adjusted requires little energy. In practice the means for tilting the brake disc machining means about the auxiliary shaft, which means can therewith be moved and be driven, are mounted on the auxiliary shaft itself.

An alternative embodiment of the device according to the invention is characterised in that the mounting means are configured as means for mounting the device on the brake callipers of the vehicle and/or as means for mounting the device on the axle.

If the device is mounted in particular to the brake calliper ears attached to the brake callipers, which already form a precise bearing surface, a machining plane for the machining means extending exactly parallel to the brake disc surface is defined automatically parallel to the brake disc surface to be worked.

If the device is mounted in particular to the axle end, additional means, usually digital means, such as a pyrometer (accelerometer), an inclinometer (level) and/or a displacement meter are required, which provide information on the basis of which the aforesaid machining plane for the machining means exactly normal to the central axis of the axle is to be found.

The machining plane found by using this mounting method also defines the direction and the position along which the machining means must move along the brake disc surface, so that the relevant tolerance requirements can be met.

Another embodiment of the device according to the invention is characterised in that the drive means comprise a chain drive, a belt drive or a gear drive connected to the brake disc machining means.

As a result, the drive means can be located outside the brake disc circumference in the operative condition of the device, and the part of the device where the machining means are located can have a flatter configuration, so that said means will still be able to carry out the surface machining operation within the limited amount of available space in a precisely controlled manner, possibly simultaneously on both opposite sides of the brake disc.

The device and the method according to the present invention will now be explained in more detail with reference to the figures below, in which like parts are indicated by the same numerals. In the figures:

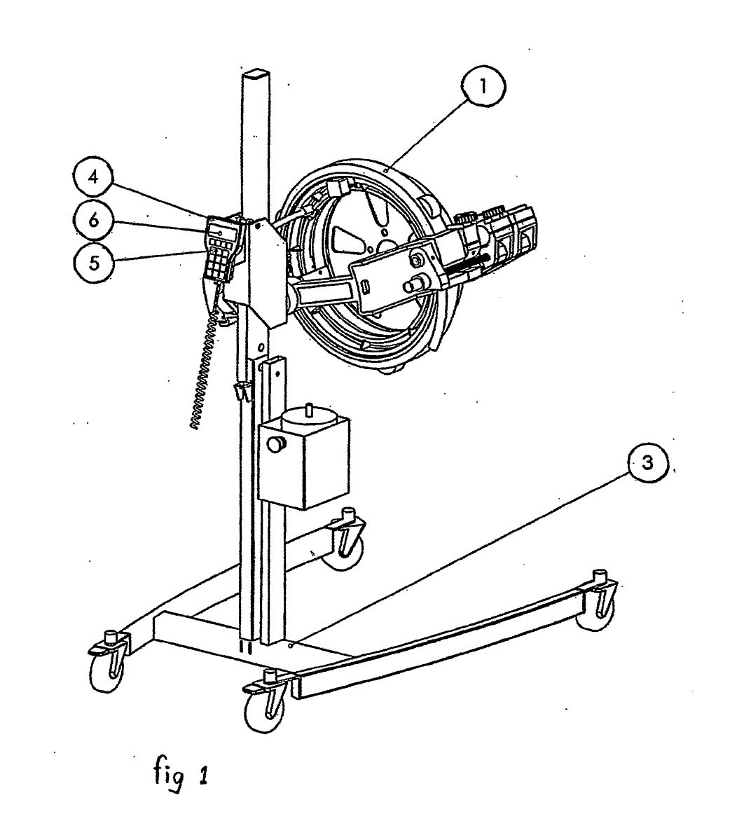

FIG. 1 is a simplified view of a device according to the invention mounted on a support;

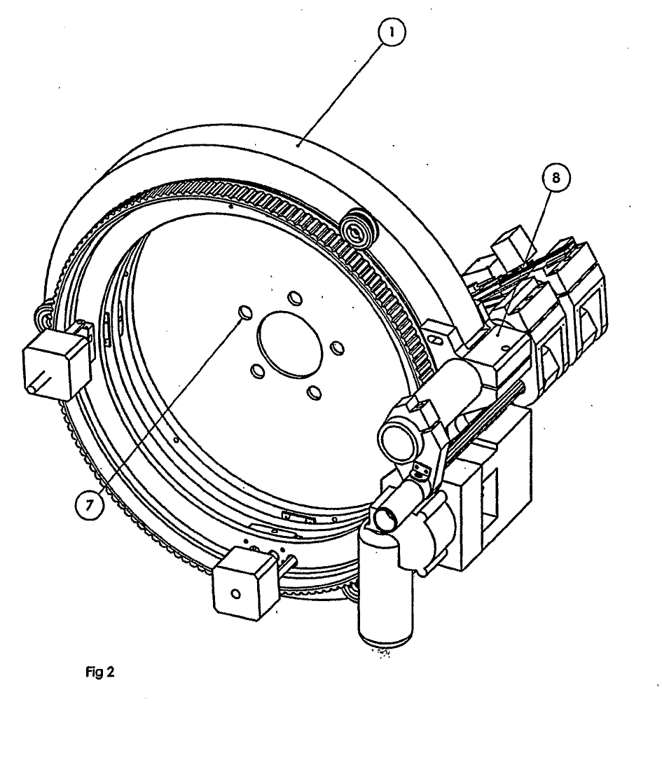

FIG. 2 is a perspective view of the device of FIG. 1;

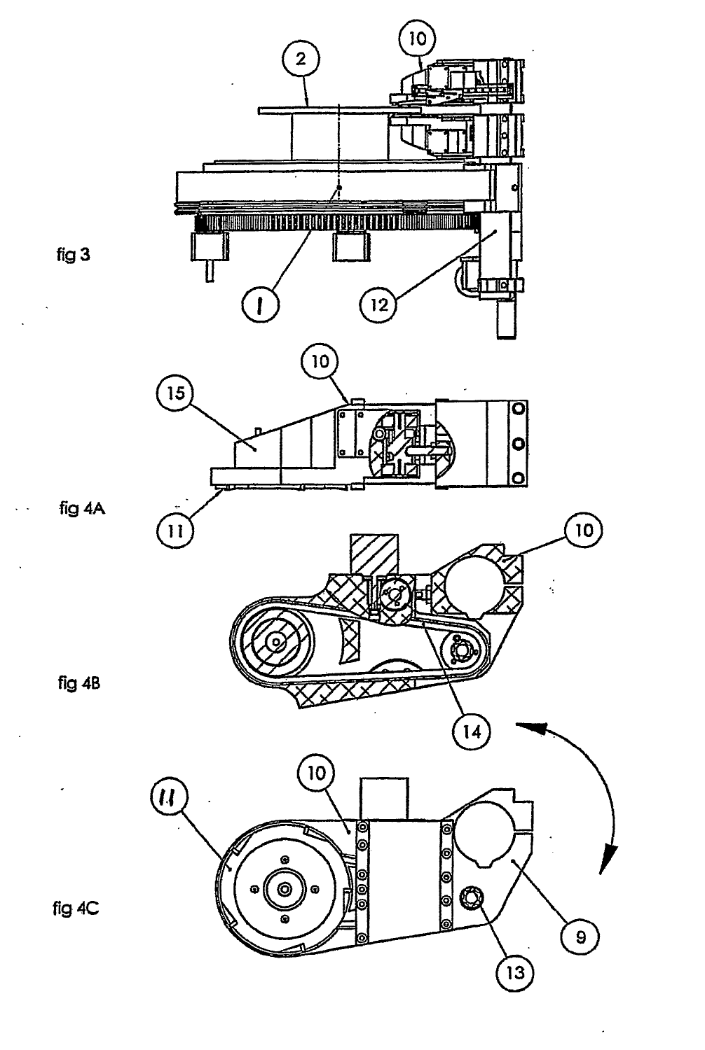

FIG. 3 is a top plan view of the device of FIG. 2; and

FIGS. 4A, 4B and 4C are a top plan view, a sectional view and a front view, respectively, of the movable, in this case tiltable, part of the device of FIG. 2.

FIG. 1 schematically shows a device 1 for independently resurfacing a brake disc 2 (FIG. 3) mounted on an axle (not shown in the figures) of a car or other vehicle. The device 1 is mounted on a movable, in particular a mobile, support 3. Mounted on said support is also a housing 4 (schematically shown), in which control means 5, a display 6 and a processor for the programmed controlling of a measuring and machining cycle are present. After an initialisation cycle has been performed, measurements are automatically carried out on the brake disc 2 and the results of said measurements are used in conjunction with data and requirements regarding the type, the construction, the dimensions and the structure of the brake for machining the surface of the brake disc in a prescribed, precisely aligned manner on the basis of the position data derived therefrom. Upon completion of the operations in question the end result is measured and the measured data in question are stored in a log file in connection with a possible subsequent retrieval thereof, giving a warranty and possible legal claims, for example liability claims, in particular product liability claims.

The device 1 comprises means 7 shown in FIG. 2 for mounting the device to the vehicle. After the vehicle has been placed on (generally) a lifting ramp, the wheel is removed from the axle and the brake pads are detached. The mounting means 7 may be configured as means for attaching the device 1 to the well-known brake callipers, in particular the brake calliper ears of the car or the truck. Because brake callipers are mounted on a well-defined bearing surface, said surface can readily function as a reference for relating thereto the machining plane that forms the plane in which the machining of the brake disc surface is to take place. The mounting means 7 may also be configured as means, shown as holes 7 inter alia in FIGS. 1 and 2, for mounting the device 1 to the axle end by means of wheel bolts. A reference is needed in that case, however, which must be determined by measurement and calculation. A possible reference is the central axis of the rotating bearing shell in the wheel bearing. Digital means to be accommodated in a suitable housing, such as an accelerometer, a level or a displacement meter may be used for defining said reference. If a fixed point on the brake disc is taken, a circle is formed upon rotation, from which the central axis can be derived. The plane in which the brake pads abut against the brake disc must extend perpendicularly to the mentioned central axis. This must have been achieved with a sufficient degree of accuracy after the brake disc surface has been worked by means 11 mounted on the axle or on the brake callipers.

If the device 1 is mounted in the above-described manner, the device also comprises an auxiliary shaft 8 which has been automatically positioned parallel to the vehicle axle during the initialisation cycle, as well as means 9 for moving a movable part 10 of the device 1 with respect to the auxiliary shaft 8. Said movement may be a rectilinear movement for translating the movable part 10, but also a tilting movement suggested in the figures (FIG. 4C) about the auxiliary shaft 8. The movable part 10 of the device 1 also comprises driveable brake disc machining means 11, such as turning, grinding, milling, boring or planing means or specific surfacing means, such as polishing or honing means, by means of which the brake disc 2 is resurfaced and given the correct position, geometry, dimension and desired surface roughness. If milling means are used, in particular a face milling cutter 11, a cylindrical cutter, an end mill, a slitting saw or the like or used so as to achieve a minimum amount of buckle or oscillation, a minimum difference in thickness across the brake disc and so as to achieve that the opposite brake surfaces will be optimally level.

The device 1 further comprises means 12, viz. a motor and, in this embodiment, a pinion coupled thereto, for rotating the vehicle axle during the resurfacing of the brake disc by the machining means 11, which means in particular move curvilinearly over the brake disc surface about the auxiliary shaft 8. The rotation means 12 may also effect rotation of the brake disc 2 in a different manner than via the wheel bolts and the holes 7. The rotational speed during the machining operation may be kept low, for example maximally 10 revolutions per minute, in particular maximally 5 revolutions per minute, more in particular maximally 1 revolution per minute. In practice a speed of 0.5 revolutions per minute is currently being used.

FIG. 3 shows that the brake disc machining means 11 are dual means so as to be able to work the two opposite surfaces of one and the same brake disc 2 simultaneously. Any machining forces exerted on each of the brake disc surfaces during the simultaneous operation thus offset one another, resulting in straight, parallel and correctly aligned brake disc surfaces after machining.

The device 1 comprises drive means 13 for rotationally driving the brake disc machining means 11. The drive means 13, as shown in the figures, comprise a chain drive 14 connected to the brake disc machining means 11. Alternatively, a belt drive or a gear drive may be used. Such a driving arrangement makes it possible to give the movable part 10 of the head 15 a flat, tapered configuration, so that it will take up little space and will be able to manoeuvre more easily in the limited space that is available in a wheel casing or between the brake calliper ears, the steering ball or other components.

1. A device for resurfacing an axle-mounted brake disc, comprising:
means for mounting the device to the vehicle,
means for moving a part of the device with respect to an auxiliary shaft extending substantially parallel to the axle,
means for rotating the axle, and
drivable brake disc machining means mounted on the movable part of the device.

2. A device according to claim 1, characterized in that the means for moving said part of the device are configured with means which are capable of tilting movement about the auxiliary shaft or means which are capable of translating movement with respect to the auxiliary shaft.

3. A device according to claim 1 or 2, characterized in that the mounting means are configured as means for mounting the device on the brake callipers of the vehicle or as means for mounting the device on the axle.

4. A device according to claim 3, characterized in that the axle mounting means are arranged for mounting the device on the axle end.

5. A device according to any one of the claims 1-4, characterized in that the brake disc machining means are arranged for working both brake disc surfaces simultaneously.

6. A device according to any one of the claims 1-5 characterized in that the brake disc machining means comprise turning, grinding, milling, boring, planing means, or specific surfacing means, such as polishing or honing means.

7. A device according to claim 6, characterized in that said milling means comprise a face milling cutter, a cylindrical cutter, an end mill or a slitting saw.

8. A device according to any one of the claims 1-7, characterized in that the device comprises drive means for rotationally driving the brake disc machining means.

9. A device according to claim 8, characterized in that the drive means comprise a chain drive, a belt drive or a gear drive connected to the brake disc machining means.

10. A device according to claim 9, characterized in that the movable or translatable or tiltable part of the device tapers off in a direction towards the brake disc machining means.

11. A method wherein a rotating axle-mounted brake disc is resurfaced by driven brake disc machining means that describe a movement over the brake disc surface.

12. A method according to either one of the claims 11 or 12, characterized in that the movement being described is a substantially rectilinear or curvilinear movement.

13. A method according to any one of the claims 11-13, characterized in that the brake disc is rotated at a speed of maximally 10 revolutions per minute, in particular maximally 5 revolutions per minute, more in particular maximally 1 revolution per minute during the machining operation.

14. A method according to any one of the claims 11-13, characterized in that the brake disc is subjected to measurements of thickness variation, Run-Out, surface roughness and geometry, for example Dishing, the results of which measurements are used for determining position data of the brake disc machining means, on the basis of which the brake disc surface can be worked.

15. A method according to any one of the claims 11-14, characterized in that the brake disc surface is subjected to an automatic measurement prior to and/or after the surfacing operation for the purpose of, respectively, determining measurement and control data for working the brake disc surface and determining warranty and liability data.
